(19) United States
(12) Patent Application Publication
(10) Pub. No.: US 2017/0051909 A1
(43) Pub. Date: Feb. 23, 2017

(54) LIGHT EMITTING DIODE (LED) LAMP

(71) Applicants: CHAMP TECH OPTICAL (FOSHAN) CORPORATION, Foshan (CN); Foxconn Technology Co., Ltd., New Taipei (TW)

(72) Inventors: YUN HONG, Foshan (CN); QIAN XIANG, Foshan (CN)

(21) Appl. No.: 14/847,844

(22) Filed: Sep. 8, 2015

(30) Foreign Application Priority Data
Aug. 21, 2015 (CN) 201520634187.0

(51) Int. Cl. F21V 29/83; F21V 21/30; F21V 23/00; F21V 1/14; F21V 29/76; F21V 7/00

(52) U.S. Cl. CPC F21V 29/83; F21V 29/76; F21V 7/0083; F21V 23/008; F21V 1/143; F21V 21/30; F21Y 2101/02

(57) ABSTRACT

A light emitting diode (LED) lamp includes a lamp holder, a light source and a driver. The lamp holder includes a first receiving chamber, a second receiving chamber and a heat dissipating structure. The first receiving chamber and the second receiving chamber are separated by the heat dissipating structure. The light source is received in the first receiving chamber. The driver is received in the second receiving chamber. The lamp holder has a first surface and a second surface opposite to the first surface. The heat dissipating structure defines a plurality of the air channels. The air channels are formed through the first surface and the second surface.

### CROSS-REFERENCE TO RELATED APPLICATIONS

This application claims priority to Chinese Patent Application No. 201520634187.0 filed on Aug. 21, 2015, the contents of which are incorporated by reference herein.

### FIELD

The subject matter relates to an LED lamp.

### BACKGROUND

Heat generated from an LED lamp may cause a high temperature of the LED lamp, which has a bad effect for a performance and security of the LED lamp.

### BRIEF DESCRIPTION OF THE DRAWINGS

Implementations of the present technology will now be described, by way of example only, with reference to the attached figures.

FIG. 1 is a top, perspective view of an LED lamp in accordance with an exemplary embodiment of the present disclosure.

FIG. 2 is a bottom, perspective view of the LED lamp of FIG. 1.

FIG. 3 is an exploded view of the LED lamp of FIG. 1.

FIG. 4 is another exploded view of the LED lamp of FIG. 1.

FIG. 5 is a top, perspective view of an LED lamp in accordance with another exemplary embodiment of the present disclosure.

FIG. 6 is a bottom, perspective view of the LED lamp of FIG. 5.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. The description is not to be considered as limiting the scope of the embodiments described herein.

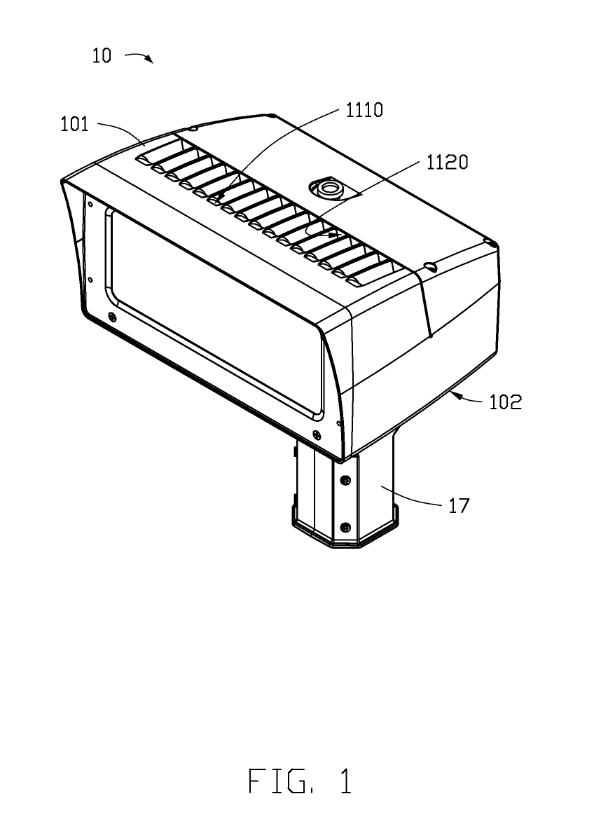

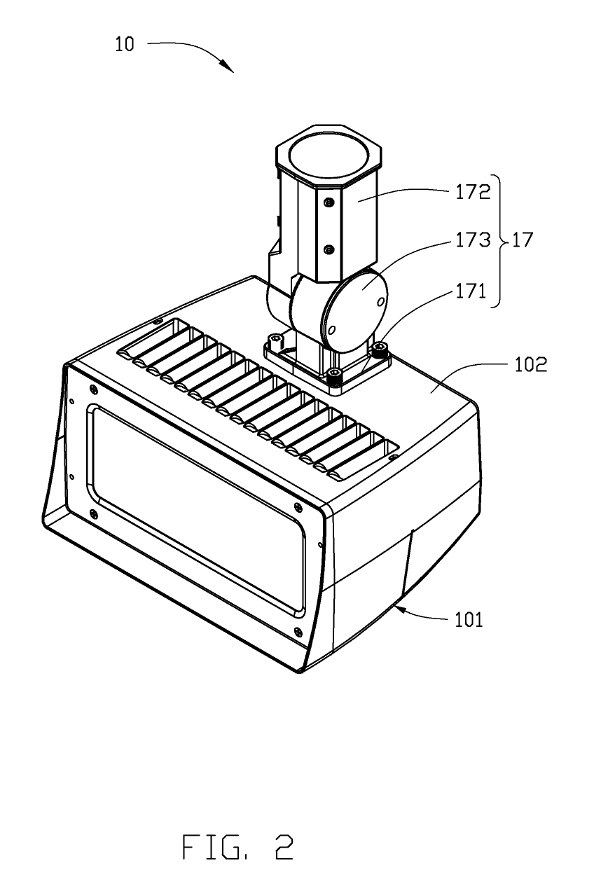

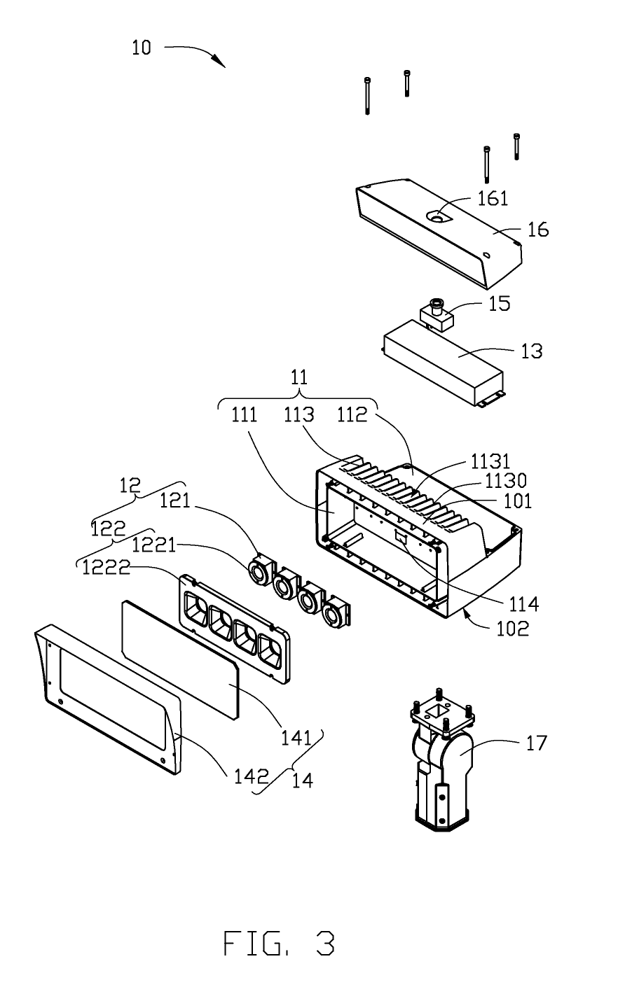

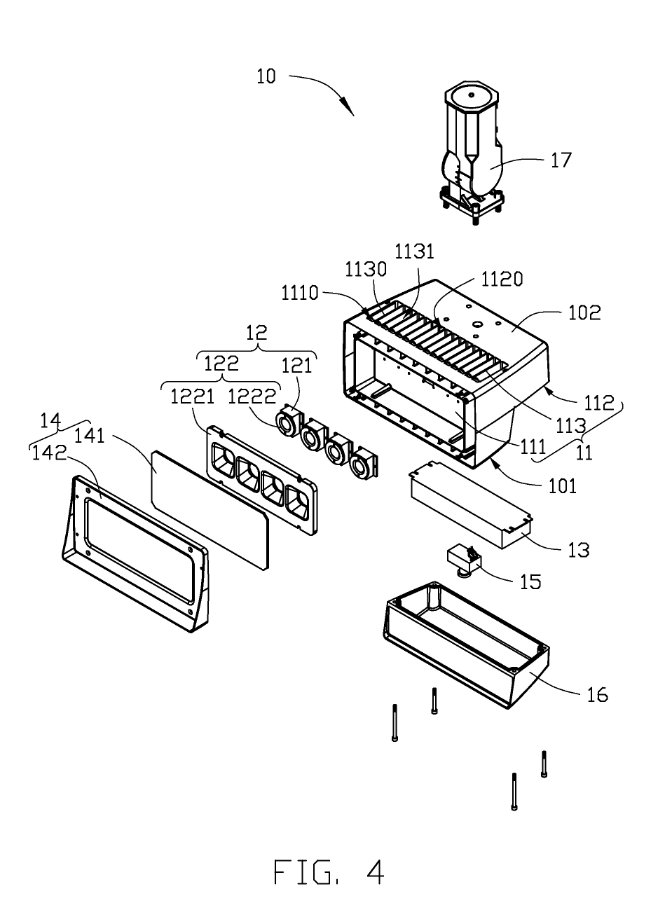

FIGS. 1-2 illustrate an LED lamp 10 as described by the present disclosure. Referring to FIGS. 3-4, the LED lamp 10 includes a lamp holder 11, a light source 12 and a driver 13.

The lamp holder 11 includes a first receiving chamber 111, a second receiving chamber 112 and a heat dissipating structure 113. The first receiving chamber 111 and the second receiving chamber 112 are respectively positioned at two ends of the heat dissipating structure 113 opposite to each other. The first receiving chamber 111 and the second receiving chamber 112 are separated by the heat dissipating structure 113. The light source 12 is received in the first receiving chamber 111. The driver 13 is received in the second receiving chamber 112.

The lamp holder 11 is substantially a cubic shaped structure. The lamp holder 11 has a first surface 101 and a second surface 102 opposite to the first surface 101. The first receiving chamber 111 and the second receiving chamber 112 are located between the first surface 101 and the second surface 102. The heat dissipating structure 113 defines a plurality of the air channels 1131. The air channels 1131 penetrate through the first surface 101 and the second surface 102.

Referring to FIGS. 1 and 4, the first receiving chamber 111 has a first heat dissipating surface 1110 facing the second receiving chamber 112. The second receiving chamber 112 has a second heat dissipating surface 1120 facing the first receiving chamber 111. The first heat dissipating surface 1110 faces the second heat dissipating surface 1120. The heat dissipating structure 113 is connected between the first heat dissipating surface 1110 and the second heat dissipating surface 1120. The first heat dissipating surface 1110 and the second heat dissipating surface 1120 are parallel to each other.

In at least one embodiment, the heat dissipating structure 113 includes a plurality of fins 1130 extending from the first heat dissipating surface 1110 to the second heat dissipating surface 1120. The fins 1130 are spaced from each other and define the air channels 1131. Each air channel 1131 is defined between two adjacent fins 1130.

Referring to FIG. 3, the lamp holder 11 can further include a connecting portion 114. The connecting portion 114 can be a channel connected between the first receiving chamber 111 and the second receiving chamber 112 configured for installing a circuit structure electrically connected between the light source 12 and the driver 13.

Referring to FIGS. 3 and 4, the light source 12 can include a plurality of LED elements 12 and a plurality of light modulators 122. Each light modulator 122 can be positioned on a light path of each LED element 12 and corresponding to the LED element 12. Each light modulator 122 can include a first portion 1221 and a second portion 1222. In this embodiment, the first portion 1221 is a reflecting ring surrounding one of the LED elements 121, and the second portion 1222 is a reflecting cup surrounding one of the first portions 1221. Each LED element 12 has a light axis. The first portion 1221 and the second portion 1222 are symmetrical about the light axis. The first portion 1221 can have a first reflecting surface, and the second portion 1222 can have a second reflecting surface. The first reflecting surface and the second reflecting surface can face the light axis. In other embodiments, the second portions 1222 can be reflecting cups each connecting to a corresponding first portion 1221. The LED lamp 10 can further include a lampshade 14 covering the light source 12. The lampshade 14 includes a covering portion 141 and a fixing portion 142. The covering portion 141 covers the light source 12 and is fixed on the lamp holder 11 by the fixing portion 142.

The LED lamp 10 can further include a light sensor 15. The light sensor 15 is received in the second receiving chamber 112. The light sensor 15 is exposed out of the lamp holder 11. In this embodiment, the LED lamp 10 can further includes a lid 16. The lid 16 covers the driver 13. A hole 161 is defined in the lid 16. The light sensor 15 is positioned in and through the hole 161 for being exposed out of the lid 16.

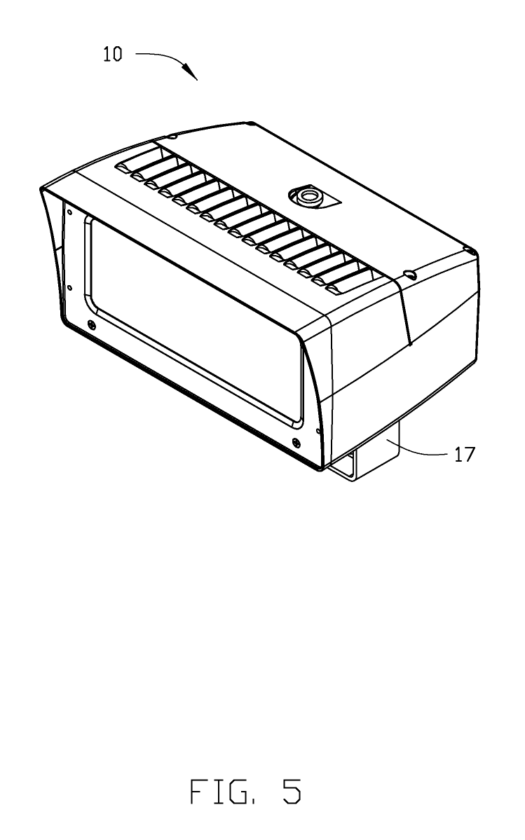

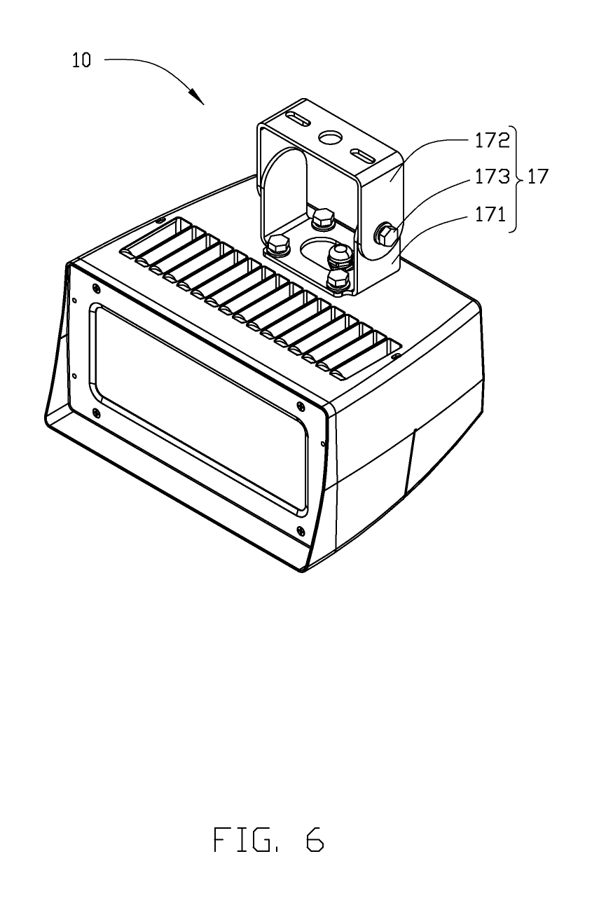

Referring to FIGS. 1-2 and 5-6, the LED lamp 10 can further include a supporting structure 17. The supporting structure 17 includes a first supporting portion 171, a second supporting portion 172 and a rotating portion 173. The rotating portion 173 is connected between the first supporting portion 171 and the second supporting portion 172. The second supporting portion 172 and the rotating portion 173 rotates surround the rotating portion 173. The supporting structure 17 can be a rotary union (referring the FIGS. 1-2) or an U-shaped structure (referring to FIGS. 5-6). The supporting structure 17 is configured for fixing the LED lamp 10 on a lamppost, a light stand or a wall.

The embodiments shown and described above are only examples. Many details are often found in the art such as the other features of an LED lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A light emitting diode (LED) lamp comprising:
a lamp holder comprising a first receiving chamber, a second receiving chamber and a heat dissipating structure separating the first receiving chamber and the second receiving chamber, the lamp holder having a first surface and a second surface opposite to the first surface, the heat dissipating structure defining a plurality of air channels penetrating through the first surface and the second surface;
a light source received in the first receiving chamber; and
a driver received in the second receiving chamber.

2. The LED lamp of claim 1, wherein the first receiving chamber and the second receiving chamber are located between the first surface and the second surface.

3. The LED lamp of claim 1, wherein the first receiving chamber has a first heat dissipating surface facing the second receiving chamber, the second receiving chamber has a second heat dissipating surface facing the first receiving chamber, and the first heat dissipating surface faces the second heat dissipating surface.

4. The LED lamp of claim 3, wherein the heat dissipating structure is connected between the first heat dissipating surface and the second heat dissipating surface.

5. The LED lamp of claim 3, wherein the first heat dissipating surface and the second heat dissipating surface are parallel to each other.

6. The LED lamp of claim 3, wherein the heat dissipating structure comprises a plurality of fins extending from the first heat dissipating surface to the second heat dissipating surface.

7. The LED lamp of claim 6, wherein the fins are spaced from each other and define the air channels, and each air channel is defined between two adjacent fins.

8. The LED lamp of claim 1, wherein the lamp holder further comprises a connecting portion, the connecting portion is a channel connected between the first receiving chamber and the second receiving chamber configured for installing a circuit structure electrically connected between the light source and the driver.

9. The LED lamp of claim 1, wherein the light source comprises a plurality of LED elements and a plurality of light modulators, each light modulator is positioned on a light path of each LED element and corresponding to the LED element.

10. The LED lamp of claim 9, wherein each light modulator comprises a first portion and a second portion, the first portion is a reflecting ring surrounding one of the LED elements, and the second portion is a reflecting cup surrounding one of the first portions.

11. The LED lamp of claim 10, wherein each LED element has a light axis, the first portion and the second portion are symmetrical about the light axis.

12. The LED lamp of claim 1, wherein the LED lamp further comprises a lampshade covering the light source, the lampshade comprises a covering portion and a fixing portion, the covering portion covers the light source and is fixed on the lamp holder by the fixing portion.

13. The LED lamp of claim 1, wherein the LED lamp further comprises a light sensor, the light sensor is received in the second receiving chamber, the light sensor is exposed out of the lamp holder.

14. The LED lamp of claim 13, wherein the LED lamp further comprises a lid, the lid covers the driver, a hole is defined in the lid, the light sensor is positioned in and through the hole for being exposed out of the lid.

15. The LED lamp of claim 1, wherein the LED lamp further comprises a supporting structure, the supporting structure comprises a first supporting portion, a second supporting portion and a rotating portion, the rotating portion is connected between the first supporting portion and the second supporting portion, the second supporting portion and the rotating portion rotates surround the rotating portion.
